(19) United States
(12) Patent Application Publication
(10) Pub. No.: US 2026/0056443 A1
(43) Pub. Date: Feb. 26, 2026

(54) ARCHITECTURE OF OPTICAL NETWORKS WITH OPTICAL SWITCHES

(71) Applicant: MELLANOX TECHNOLOGIES, LTD., Yokneam (IL)

(72) Inventors: Ran HASSON RUSO, Pardes Hanna-Karkur (IL); Dimitrios KALAVROUZIOTIS, Papagou (GR); Paraskevas BAKOPOULOS, Ilion (GR); Ioannis (Giannis) PATRONAS, Piraeus (GR); Elad MENTOVICH, Tel Aviv (IL)

(73) Assignee: MELLANOX TECHNOLOGIES, LTD., Yokneam (IL)

(21) Appl. No.: 18/814,825

(22) Filed: Aug. 26, 2024

(30) Foreign Application Priority Data
Aug. 20, 2024 (GR) 20240100582

(51) Int. Cl. G02F 1/295

(52) U.S. Cl. CPC G02F 1/295

(57) ABSTRACT

Some embodiments of the present disclosure are directed to an architecture of optical networks with optical switches. For example, an optical switch assembly may include a first switch including first switch outputs, where the first switch may be configured to have a first switch orientation corresponding to one of the first switch outputs, a second switch including second switch outputs, where the second switch may be configured to have a second switch orientation corresponding to one of the second switch outputs, a first optical element configured to receive a first switch output, receive a second switch output, and transmit the first switch output and the second switch output via a first combined output, and a second optical element configured to receive another first switch output, receive another second switch output, and transmit the other first switch output and the other second switch output via a second combined output.

### CROSS-REFERENCE TO RELATED APPLICATION

The present application claims the benefit of Greek patent application No. 20240100582 for an “Architecture of Optical Networks with Optical Switches” filed Aug. 20, 2024, which is hereby incorporated by reference in its entirety.

### TECHNOLOGICAL FIELD

The present disclosure relates to architectures of optical networks with optical elements.

### BACKGROUND

Presently, there are efforts to explore alternative means to complementary metal-oxide-semiconductor (CMOS) manufacturing in developing datacenter switches as there are concerns regarding the ability of CMOS technology to sustain the projected rise in data traffic. One alternative that is being explored is the incorporation of photonics into datacenters by way of optical switches.

### GENERAL DESCRIPTION

In one aspect, the present disclosure is directed to an optical switch assembly that may include a first switch including (i) a first switch input and (ii) multiple first switch outputs, where the first switch may be configured to have a first switch orientation corresponding to one of the first switch outputs and/or a second switch that may include (i) a second switch input and (ii) multiple second switch outputs, where the second switch may be configured to have a second switch orientation corresponding to one of the second switch outputs. In some embodiments, the optical switch assembly may include a first optical element that may be configured to (i) receive, from the first switch, a first switch output of the first switch outputs, (ii) receive, from the second switch, a second switch output of the second switch outputs, and (iii) transmit the first switch output and the second switch output via a first combined output. Further, the optical switch assembly may include a second optical element configured to (i) receive, from the first switch, another first switch output of the first switch outputs, (ii) receive, from the second switch, another second switch output of the second switch outputs, and (iii) transmit the other first switch output and the other second switch output via a second combined output.

In some embodiments, the first switch may be configured to have multiple first switch orientations. Further, each first switch orientation of the multiple first switch orientations may be configured to correspond to a respective first switch output of the first switch outputs. Additionally, or alternatively, the second switch may be configured to have multiple second switch orientations. In some embodiments, each second switch orientation may be configured to correspond to a respective second switch output of the second switch outputs.

In some embodiments, the optical switch assembly may include M switches, where M may be a positive integer, each of the M switches may be optically coupled within the optical switch assembly, and the M switches may include the first switch and the second switch. Further, the optical switch assembly may include N optical elements, where N may be a positive integer and the N optical elements may include the first optical element and the second optical element. Additionally, or alternatively, N/M may correspond to a number of switch outputs per switch of the M switches.

In some embodiments, the N optical elements may be divided into M subsets of N/M optical elements and each subset of the M subsets of the N optical elements may correspond to a switch of the M switches. Further, the N/M switch outputs of a switch may be optically coupled to a corresponding optical element of the corresponding subset of N/M optical elements to the switch. Additionally, or alternatively, N/M optical fibers may optically couple corresponding optical elements from each subset of the M subsets of the N optical elements.

In some embodiments, the first switch may be an electromechanical switch. Further, the first optical element may be a micro-electromechanical system (MEMS).

In some embodiments, the optical switch assembly may be configured to support propagation of a single mode of light. Additionally, or alternatively, the optical switch assembly may be configured to support propagation of multiple modes of light.

In some embodiments, the optical switch assembly may be configured to support different types of inputs, outputs, and intermediate multi-mode fibers. Additionally, or alternatively, the first optical element may be a multimode combiner. Further, the optical switch assembly may be deployed in a datacenter.

In another aspect, the present disclosure is directed to an optical system that includes a plurality of optical switch assemblies. Further, an optical switch assembly of the plurality of optical switch assemblies may include an optical switch, where the optical switch may be configured to have at least one input and a plurality of output; and a plurality of optical elements, where an optical element of the plurality of optical elements may include a plurality of optical element inputs and an optical element output. Additionally, or alternatively, the optical element may be configured to receive at least one output of the optical switch as an optical element input of the optical element inputs and to combine the optical element input with one or more additional optical element inputs of the optical element into the optical element output, and the optical switch assembly of the plurality of optical switch assemblies may be optically coupled to the remaining plurality of optical switch assemblies.

In some embodiments, the optical element of the plurality of optical elements of the optical switch assembly may be configured to be optically coupled to a corresponding optical element of each of the remaining plurality of optical switch assemblies. Further, the one or more additional optical element inputs may originate from a corresponding optical element of a neighboring optical switch assembly of the plurality of optical switch assemblies. Additionally, or alternatively, the optical element of the plurality of optical elements of the optical switch assembly may be configured to receive an output of the plurality of outputs of an optical switch for each of the remaining optical switch assemblies of the plurality of optical switch assemblies of the optical system as the one or more additional optical element inputs.

In some embodiments, the optical switch may be configured to transmit from a single output of the plurality of outputs at a given time. Further, the optical system may be deployed in a datacenter.

In another aspect, the present disclosure is directed to a system that includes a plurality of network devices configured in a hierarchical network topology. At least one network device of the plurality of network devices may include an architecture of optical networks that includes an optical network topology for an optical switch assembly configured to combine M 1×N switches to a scalable N×M optical switch assembly, where N and M are positive integers, and where N is a number of outputs of a switch of the M 1×N switches.

In some embodiments, the architecture of optical networks may be configured as an electromechanical switch and multimode combiner based optical network in a crossbar array or modified Spanke-Beneš network topology. Additionally, or alternatively, the optical network topology may be identical to the optical switch assembly.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 illustrates a crossbar array topology for an optical switch assembly, in accordance with an embodiment of the disclosure;

FIG. 2 illustrates a crossbar array topology for an optical system, in accordance with an embodiment of the disclosure;

FIG. 3 illustrates a modified Spanke-Beneš topology for an optical system, in accordance with an embodiment of the disclosure;

FIGS. 4A-4C illustrate an optical switch in a plurality of orientations, in accordance with an embodiment of the disclosure;

FIGS. 4D-4E illustrate an electromechanical optical switch, in accordance with an embodiment of the disclosure;

FIG. 5 illustrates a modified Spanke-Beneš topology for an optical switch assembly, in accordance with an embodiment of the disclosure;

FIG. 6 illustrates a crossbar array topology for an optical switch assembly, in accordance with an embodiment of the disclosure;

FIG. 7 illustrates a crossbar array topology for an optical switch assembly, in accordance with an embodiment of the disclosure;

FIG. 8 illustrates an exemplary optical switch assembly, in accordance with an embodiment of the present disclosure;

FIG. 9 illustrates a system, in accordance with an embodiment of the present disclosure; and

FIG. 10 illustrates a modified fat tree topology, in accordance with an embodiment of the present disclosure.

### DETAILED DESCRIPTION OF EMBODIMENTS

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). As used herein, terms such as “top,” “about,” “around,” and/or the like are used for explanatory purposes in the examples provided below to describe the relative position of components or portions of components. As used herein, the terms “substantially” and “approximately” refer to tolerances within manufacturing and/or engineering standards. Like numbers refer to like elements throughout. No element, act, or instruction used herein should be construed as critical or essential unless explicitly described as such.

As noted, there are efforts to explore alternative means to CMOS manufacturing in developing datacenter switches as there are concerns regarding the ability of CMOS technology to sustain the projected rise in data traffic. One alternative that is being explored is the incorporation of photonics into datacenters by way of optical switches. Optical switches may have the capability of meeting the capacity demands required of datacenter switches, and optical switches may have the added benefit of higher resiliency to a link or device failure, reducing the risk of downtime.

The use of optical switch assemblies within optical networks may be constrained by the size of the switch as well as the input-output configurations available (e.g., a single input mapped to a plurality of outputs). For example, one type of optical switch assembly may include one or more electromechanical optical switches, which have high reliability and low insertion loss, but may be relatively large and slow since electromechanical optical switches may include a mechanical part in operation. Further, electromechanical optical switches have traditionally been relegated to simpler topologies (e.g., 1×N optical switches) rather than larger topologies (e.g., crossbar) due to their physical size constraints. Further, the electromechanical optical switches may operate in a set-and-forget topology, where the electromechanical optical switches may not require frequent reconfiguration (e.g., the electromechanical optical switches may have a set switching profile they maintain and may only reconfigure in the event of network disruptions, power outages, and/or the like). Optical networks of the present disclosure enjoy the benefits of electromechanical optical switches, such as ultra-low optical loss, lower power consumption, scalability, and high reliability, while mitigating the drawbacks associated with electromechanical optical switches.

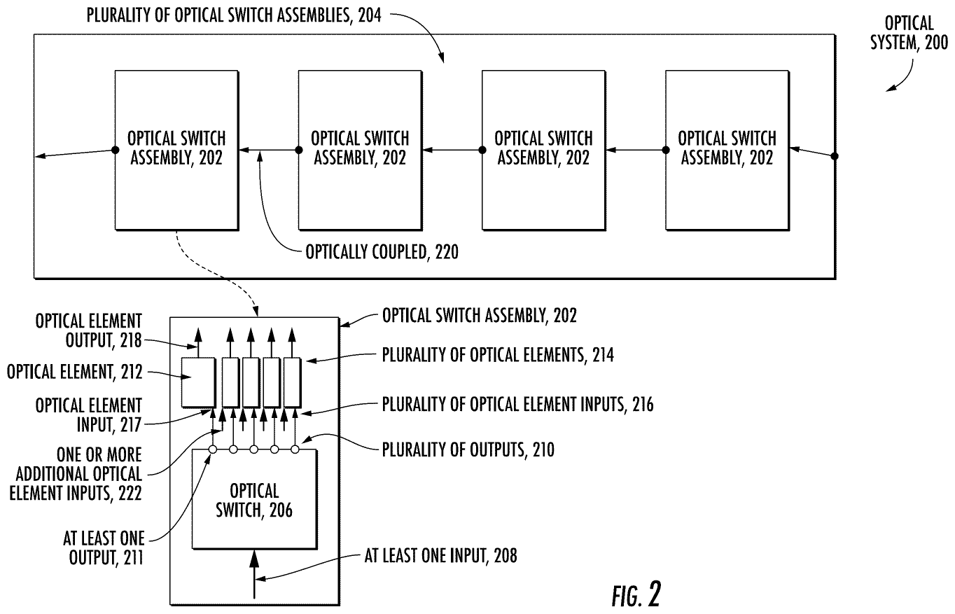

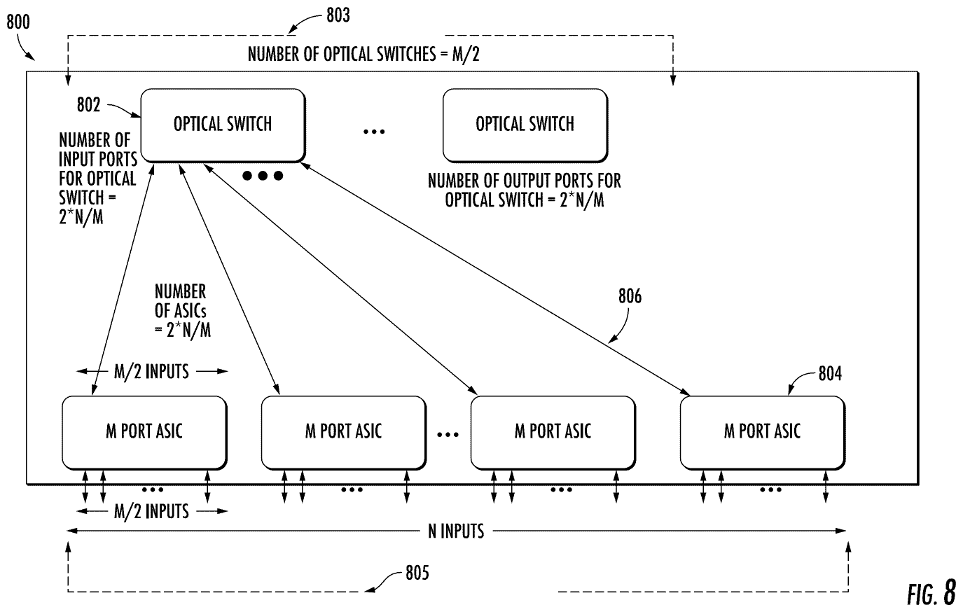

An optical switch assembly with a plurality of outputs may enable crossbar connections or modified Spanke-Beneš connections within an optical network while adhering to size constraints of a given optical network. In some embodiments, the present disclosure is directed to a novel architecture of optical networks which may include a plurality of optical elements. Additionally, or alternatively, the optical network of the present disclosure may combine a plurality of optical switches (e.g., electromechanical optical switches) with a plurality of fiber optics components (e.g., multimode combiners) in a crossbar network topology and/or a modified Spanke-Beneš network topology. The proposed designs in FIGS. 8-10 may be employed in one or more of the topologies depicted in FIGS. 2-7 and/or may offer a wide range of different capabilities and functionalities depending on the requirements of the overall system.

In some embodiments, an optical switch assembly may include a plurality (M) of electromechanical optical switches (e.g., a switch with a mechanical element to change which optical fiber an optical input is directed to) each with a plurality (N) of possible outputs. Further, each output of an electromechanical switch may correspond to a possible orientation of the electromechanical switch. In this way, an optical input to an electromechanical switch may be directed down a certain path of the optical switch assembly. Additionally, or alternatively, each output of an electromechanical switch may be directed to a multimode combiner for an optical switch assembly configured to support multimode propagation (e.g., multiple modes of light). By directly providing the output of the electromechanical switches to multimode combiners, instead of a second set of switches, provides technical advantages in terms of reduced power consumption and a more compact architecture. Further, the multimode combiner may be configured to receive two or more optical inputs and may be configured to combine the two or more optical inputs into a single optical output. In some embodiments, an output of an electromechanical switch may be directed to a micro-electromechanical systems (MEMS) switch for an optical switch assembly configured to support single mode propagation (e.g., a single mode of light). Further, if an optical switch assembly includes a single-mode fiber, a latching MEMs may be employed in the optical switch assembly.

In some embodiments, an optical switch assembly may optically couple the multimode combiner or MEMS switch associated with a specific orientation of an electromechanical optical switch with other multimode combiners or MEMS switches of a same orientation of the remaining M−1 electromechanical optical switches. Additionally, or alternatively, an optical switch assembly may optically couple the multimode combiner or MEMS switch associated with a specific orientation of an electromechanical optical switch with optical outputs of a similar orientation of the remaining M−1 electromechanical optical switches.

Datacenters may include multiple network switches in a particular topology, such as a fat tree topology, a slim fly topology, a dragonfly topology, and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

Optical Data Center Networks rely on allocation and deallocation of light paths from the data sources to the destinations end-ports to guarantee no light collisions and data loss occur in the fabric. Traditionally the allocation algorithms are run from a central entity which considers the entire demand for source and destination flows and try to find the most dense mapping of these demands to network resources over a single or multiple time periods.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e., without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common datacenter interconnection topologies (e.g., fat trees, Slim Fly, and Dragonfly+).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an ASIC are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

The optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

Embodiments of the present disclosure may experience negligible power consumed during the steady state, in which the electromechanical switches are not moving, while the MEMS are locked in a latching state. Further, topologies of the present disclosure may be used for increased resiliency by defining a number of input and a number of output signals to remain unused during operation. As will be appreciated by one of ordinary skill in the art in view of the present disclosure, the most advanced switches available in the market today employ ASICs (Application-Specific Integrated Circuits) equipped with 512 data lanes (256× 200 GbE ports) capable of handling up to 51.2 Terabits per second (Tb/s) of traffic. However, these switches come at a cost—as these switches consume as much as 500 watts of power, and the optical transceiver interfaces attached to them also consume a significant amount of power.

One alternative that is being explored is the incorporation of photonics into datacenters by way of optical switches. In some embodiments, optical switches may have the capability of meeting the capacity demands required of datacenter switches and/or they may have the added benefit of higher resiliency to a link or device failure, thus reducing the risk of downtime. Additionally, or alternatively, an electromechanical optical switch may be one type of optical switch that has high reliability and low insertion loss but may be relatively large and slow since it may incorporate a mechanical part in operation. Electromechanical optical switches have traditionally been relegated to simpler topologies (e.g., 1×N switches) rather than larger topologies (e.g., crossbar) due to their physical size constraints. Embodiments of the present disclosure may go a step further into the architecture of electromechanical switch based optical networks by combining the switches with non-reciprocal multimode fiber optic components, in a crossbar network topology, modified Spanke-Beneš topology, a modified fat tree topology and/or the like. This way, the rotational stages may still operate in 1×N sub-networks, while the assembled topology may enable full crossbar connectivity.

Optical networks of the present disclosure may enjoy the benefits of electromechanical optical switches, such as ultra-low optical loss, lower power consumption, scalability, and/or high reliability, while mitigating the drawbacks associated with electromechanical optical switches. In this way, the present disclosure extends the market of optical networks of electromechanical switches from just test and measurement equipment to datacenter optical interconnects.

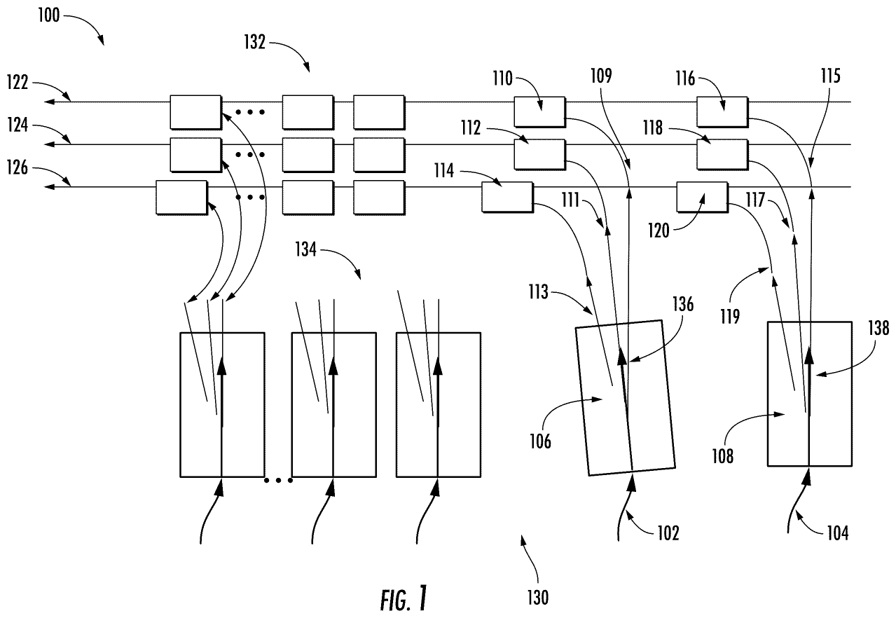

FIG. 1 illustrates a crossbar array topology for an optical switch assembly 100, in accordance with an embodiment of the disclosure. In some embodiments, the optical switch assembly 100 may include a first switch 106 that may include (i) a first switch input 102 and (ii) multiple first switch outputs 109, 111, and 113, where the first switch 106 may be configured to have a first switch orientation 136 corresponding to one of the first switch outputs 109, 111, and 113. Further, the optical switch assembly 100 may include a second switch 108 that may include (i) a second switch input 104 and (ii) multiple second switch outputs 115, 117, and 119, where the second switch 108 may be configured to have a second switch orientation 138 corresponding to one of the second switch outputs 115, 117, and 119.

In some embodiments, the optical switch assembly 100 may include a first optical element 110 configured to (i) receive, from the first switch 106, a first switch output 109 of the first switch outputs 109, 111, and 113, (ii) receive, from the second switch 108, a second switch output 115 of the second switch outputs 115, 117, and 119, and (iii) transmit the first switch output 109 and the second switch output 115 via a first combined output 122. Further, the optical switch assembly 100 may include a second optical element 112 configured to (i) receive, from the first switch 106, another first switch output 111 of the first switch outputs 109, 111, and 113, (ii) receive, from the second switch 108, another second switch output 117 of the second switch outputs 115, 117, and 119, and (iii) transmit the other first switch output 111 and the other second switch output 117 via a second combined output 124 (e.g., a multimode combiner receives two separate optical inputs, combines the two separate optical inputs into a single optical output, and/or transmits the single optical output). As will be appreciated by one of ordinary skill in the art in view of the present disclosure, the second switch output 115 and/or the other second switch output 117 may be first combined with another output in a different optical element prior to combining with the first switch output 109 and/or the other first switch output 111.

In some embodiments, the first switch 106 may be configured to have multiple first switch orientations 136 (e.g., an electromechanical switch may have a plurality of optical paths to transmit an optical signal from and the electromechanical switch may be actuated to align an optical input to the electromechanical switch to one of the plurality of optical paths of the electromechanical switch). Further, each first switch orientation of the multiple first switch orientations 136 may be configured to correspond to a respective first switch output of the first switch outputs 109, 111, and 113. As will be appreciated by one of ordinary skill in the art in view of the present disclosure, the other first switch output 111 may refer to a same optical output as the first switch output 109 with a same switch orientation of the multiple first switch orientations 136, a same optical output as the first switch output 109 with a different switch orientation of the multiple first switch orientations 136, a different optical output than the first switch output 109 with a different switch orientation of the multiple first switch orientations 136, and/or the like.

In some embodiments, the second switch 108 may be configured to have multiple second switch orientations 138. Further, each second switch orientation of the multiple second switch orientations 138 is configured to correspond to a respective second switch output of the second switch outputs. As will be appreciated by one of ordinary skill in the art in view of the present disclosure, the other second switch output 117 may refer to a same optical output as the second switch output 115 with a same switch orientation of the multiple second switch orientations 138, a same optical output as the second switch output 115 with a different switch orientation of the multiple second switch orientations 138, a different optical output than the second switch output 115 with a different switch orientation of the multiple second switch orientations 138, and/or the like.

In some embodiments, the optical switch assembly 100 may include M switches 130, where M may be a positive integer, where each of the M switches 130 may be optically coupled within the optical switch assembly 100, and where the M switches 130 may include the first switch 106 and the second switch 108. Further, the optical switch assembly 100 may include N optical elements 132, where N may be a positive integer, and where the N optical elements 132 may include the first optical element 110 and the second optical element 112. Additionally, or alternatively, N/M may correspond to a number of switch outputs 134 per switch of the M switches.

In some embodiments, the N optical elements 132 may be divided into M subsets of N/M optical elements and each subset of the M subsets of the N optical elements 132 may correspond to a switch of the M switches 130. Further, the N/M switch outputs 134 of a switch may be optically coupled to a corresponding optical element of the corresponding subset of N/M optical elements to the switch. Additionally, or alternatively, the optical switch assembly 100 may include N/M optical fibers optically coupled to corresponding optical elements from each subset of the M subsets of the N optical elements.

In some embodiments, the first optical element 110 may be a micro-electromechanical system (MEMS). Additionally, or alternatively, the first switch 106 may be an electromechanical switch.

In some embodiments, the optical switch assembly 100 is configured to support propagation of a single mode of light. Further, the optical switch assembly 100 may be configured to support propagation of multiple modes of light. Additionally, or alternatively, the optical switch assembly 100 may be configured to support different types of inputs, outputs, and intermediate multi-mode fibers. In some embodiments, the first optical element 110 may be a multimode combiner.

As will be appreciated by one of ordinary skill in the art in view of the present disclosure, the optical switch assembly 100 may include additional embodiments, such as any single embodiment or any combination of embodiments described herein. Although FIG. 1 shows example elements of the optical switch assembly 100, in some embodiments, the optical switch assembly 100 may include additional elements, fewer elements, different elements, or differently arranged elements than those depicted in FIG. 1.

FIG. 2 illustrates a crossbar array topology for an optical system 200, in accordance with an embodiment of the disclosure. The optical system 200 may include a plurality of optical switch assemblies 204, where an optical switch assembly 202 of the plurality of optical switch assemblies 204 may include an optical switch 206, where the optical switch 206 may be configured to have at least one input 208 and a plurality of outputs 210 and a plurality of optical elements 214, where an optical element 212 of the plurality of optical elements 214 may include a plurality of optical element inputs 216 and an optical element output 218. For example, optical switch 206 may be configured to have I inputs 208 and N/M outputs. Further, the optical element 212 may be configured to receive at least one output 211 of the optical switch assembly 202 as an optical element input 217 of the optical element inputs 216 and to combine the optical element input 217 with one or more additional optical element inputs 222 of the optical element 212 into the optical element output 218. Additionally, or alternatively, the optical switch assembly 202 of the plurality of optical switch assemblies 204 may be optically coupled 220 to the remaining plurality of optical switch assemblies 204.

In some embodiments, the optical element 212 of the plurality of optical elements 214 of the optical switch assembly 202 may be configured to be optically coupled to a corresponding optical element of each of the remaining plurality of optical switch assemblies 204. Further, the one or more additional optical element inputs 222 may originate from a corresponding optical element of a neighboring optical switch assembly of the plurality of optical switch assemblies 204. In some embodiments, the optical switch 206 may be configured to transmit from a single output of the plurality of outputs 210 at a given time.

In some embodiments, the optical switch assembly 202 of the optical system 200 may be similar to one or more of the optical switch assemblies 100, 500, 600, and/or 700 as shown and described herein with respect to FIGS. 1, 5, 6, and 7, respectively. As will be appreciated by one of ordinary skill in the art in view of the present disclosure, the optical system 200 may include additional embodiments, such as any single embodiment or any combination of embodiments described herein. Although FIG. 2 shows example elements of the optical system 200, in some embodiments, the optical system 200 may include additional elements, fewer elements, different elements, or differently arranged elements than those depicted in FIG. 2.

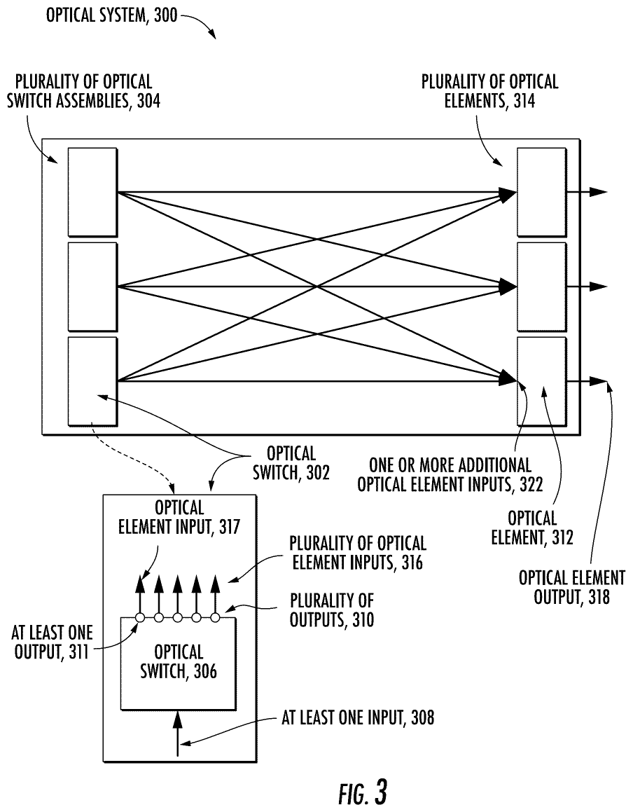

FIG. 3 illustrates a modified Spanke-Beneš topology for an optical system, in accordance with an embodiment of the disclosure. The optical system 300 may include a plurality of optical switch assemblies 304, where an optical switch assembly 302 of the plurality of optical switch assemblies 304 may include an optical switch 306, where the optical switch 306 may be configured to have at least one input 308 and a plurality of outputs 310, and a plurality of optical elements 314, where an optical element 312 of the plurality of optical elements 314 may include a plurality of optical element inputs 316 and an optical element output 318. Further, the optical element 312 may be configured to receive at least one output 311 of the optical switch assembly 302 as an optical element input 317 of the optical element inputs 316 and to combine the optical element input 317 with one or more additional optical element inputs 322 of the optical element 312 into the optical element output 318. Additionally, or alternatively, the optical switch assembly 302 of the plurality of optical switch assemblies 304 may be optically coupled to the remaining plurality of optical switch assemblies 304.

In some embodiments, the optical element 312 of the plurality of optical elements 314 of the optical switch assembly 302 may be configured to receive an output of the plurality of outputs 310 of an optical switch 306 for each of the remaining optical switch assemblies 302 of the plurality of optical switch assemblies 304 of the optical system 300 as the one or more additional optical element inputs 322. Further, the optical switch 306 may be configured to transmit from a single output of the plurality of outputs 310 at a given time.

In some embodiments, the optical switch assembly 302 of the optical system 300 may be similar to one or more of the optical switch assemblies 100, 500, 600, and/or 700 as shown and described herein with respect to FIGS. 1, 5, 6, and 7, respectively. As will be appreciated by one of ordinary skill in the art in view of the present disclosure, the optical system 300 may include additional embodiments, such as any single embodiment or any combination of embodiments described herein. Although FIG. 3 shows example elements of the optical system 300, in some embodiments, the optical system 300 may include additional elements, fewer elements, different elements, or differently arranged elements than those depicted in FIG. 3.

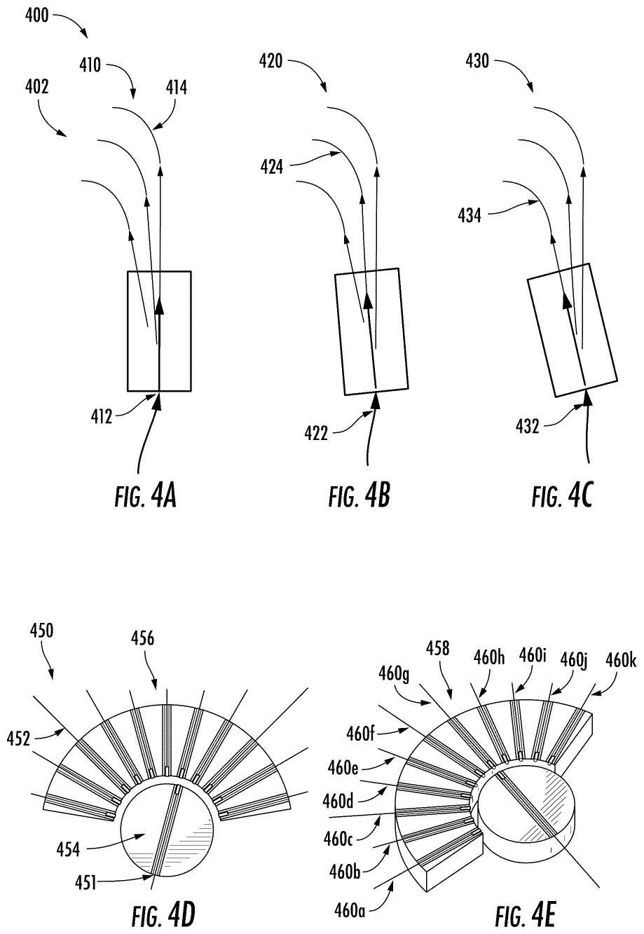

FIGS. 4A-4C illustrate an optical switch 400 (e.g., an electromechanical optical switch 450 as shown and described herein with respect to FIGS. 4D-4E) in a plurality of orientations 410, 420, and/or 430, in accordance with an embodiment of the present disclosure. As shown in FIGS. 4A-4C, the optical switch 400 may include switch inputs 412, 422, and/or 432 and a plurality of outputs 402. In some embodiments, the switch inputs 412, 422, and/or 432 may refer to similar and/or different optical inputs into the optical switch 400. In some embodiments, the plurality of outputs 402 may include switch outputs 414, 424, 434, and/or any number of other switch outputs.

In some embodiments, the optical switch 400 may include a plurality of orientations, where an orientation of the plurality of orientations may be associated with a switch output 414, 424, and/or 434 of the plurality of outputs 402. For example, the plurality of orientations may include a first switch orientation 410 associated with the switch output 414, a second switch orientation 420 associated with the switch output 424, a third orientation 430 associated with the switch output 434, and/or any other number of orientations associated with any other number of switch outputs. Further, the plurality of outputs 402 of the optical switch may be output via a fiber lens assembly (e.g., similar to a fiber lens assembly 452 shown and described herein with respect to FIGS. 4D-4E). In some embodiments, the optical switch 400 may include a rotating stage (e.g., similar to a rotating stage 454 shown and described herein with respect to FIGS. 4D-4E). Further, the rotating stage may be actuated (e.g., via a mechanical, electrical, and/or magnetic means) to rotate to the orientation 410, 420, and/or 430 of the plurality of orientations to transmit a switch input 412, 422, and/or 432 to the optical switch 400 from the switch output 414, 424, and/or 434 of the plurality of outputs 402.

For example, the optical switch 400 may be configured to initially be in the first switch orientation 410. The optical switch 400 may then rotate, via the rotating stage, to the second switch orientation 420 based on the requirements of an optical system. The optical input 422 to the optical switch 400 may then be transmitted via the switch output 424 associated with the second switch orientation 420 to a further optical element in the optical system. In some embodiments, the optical switch 400 may be configured to initially be in any of the plurality of orientations. Further, the optical switch may be configured to rotate, via the rotating stage, to any of the orientations of the plurality of orientations based on the requirements of the optical system.

As will be appreciated by one of ordinary skill in the art in view of the present disclosure, the optical switch 400 may include additional embodiments, such as any single embodiment or any combination of embodiments described herein. Although FIG. 1 shows example elements of the optical switch 400, in some embodiments, the optical switch 400 may include additional elements, fewer elements, different elements, or differently arranged elements than those depicted in FIG. 4.

FIGS. 4D-4E illustrate an electromechanical optical switch 450 in a 2-dimensional view 456 and a 3-dimensional view 458, in accordance with an embodiment of the disclosure. As shown in FIGS. 4D-1E, the electromechanical optical switch 450 may include a rotating stage 454, an optical input 451, and/or a fiber lens assembly 452. As also shown in FIGS. 4D-1E, the fiber lens assembly 452 may include a plurality of outputs in the form of fiber lenses 460a-460k.

In some embodiments, the electromechanical optical switch 450 may be configured to be in an initial orientation set by the rotating stage 454. Further, the rotating stage 454 may be actuated (e.g., via a mechanical, electrical, and/or magnetic means) to rotate to a specific orientation to transmit the optical input 451 to a specific fiber lens of the fiber lens assembly 452. For example, and as shown in FIGS. 4D and 4E, the rotating stage 454 is rotated to an orientation to transmit the optical input 451 to fiber lens 460g of the fiber lens assembly 452.

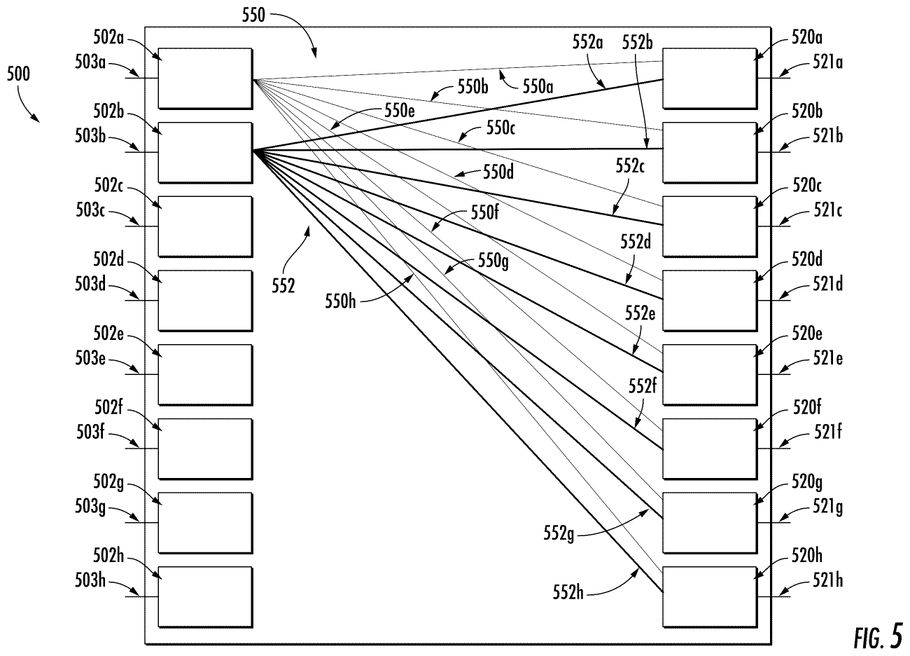

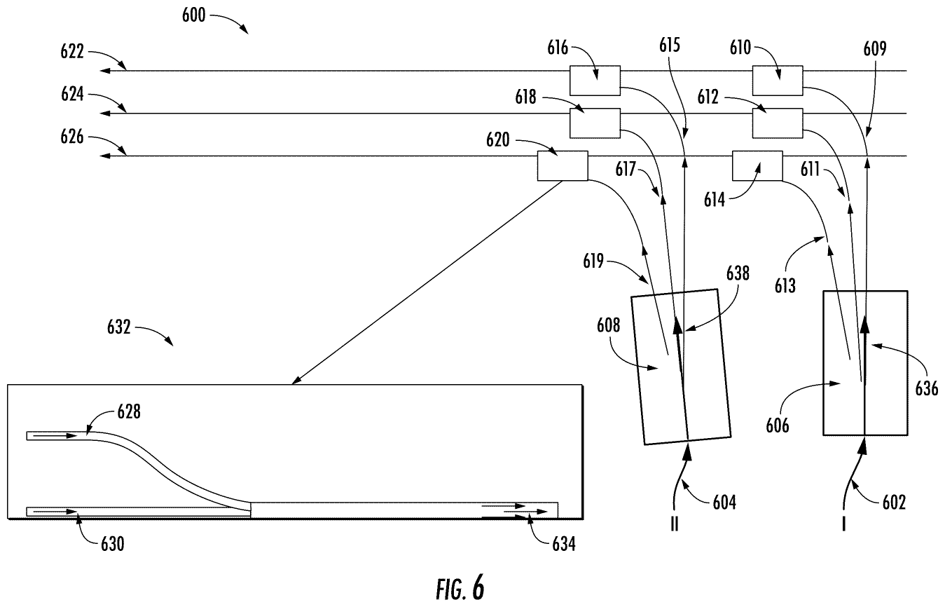

In some embodiments, the electromechanical optical switch 450 may be set to a specific orientation to transmit the optical input 451 to a specific fiber lens of the fiber lens assembly 452 and only set to a new orientation in the event of a disruption (e.g., a “set and forget” mode of operation). In some embodiments, the electromechanical optical switch 450 may serve as an optical switch in an optical switch assembly (e.g., the optical switch assemblies 500, 600, and/or 700 shown and described herein with respect FIGS. 5-7). Further, the fiber lens assembly 452 may have a plurality of outputs each associated with an optical element (e.g., similar to the multimode combiner 632 shown and described herein with respect to FIG. 6).

FIG. 5 illustrates a modified Spanke-Beneš topology for an optical switch assembly 500, in accordance with an embodiment of the disclosure. As shown in FIG. 5, the optical switch assembly 500 may include a plurality of optical switches 502a-502h and a plurality of optical elements 520a-520h. As also shown in FIG. 5, each of the optical switches 502a-502h may include a corresponding switch input 503a-503h, and each of the optical elements 520a-520h may include a corresponding optical element output 521a-521h. Furthermore, as shown in FIG. 5 with respect to optical switches 502a and 502b, each of the optical switches 502a-502h may include a plurality of switch outputs, where the switch outputs of the first optical switch 502a are switch outputs 550a-550h and the switch outputs of the second optical switch 502b are switch outputs 552a-552h.

As shown in FIG. 5 with respect to a first optical switch 502a, each of the switch outputs 550a-550h may correspond to an optical element of the plurality of optical elements 520a-520h. For example, and as shown in FIG. 5, switch output 550a may correspond to a first optical element 520a, and each of switch outputs 550b-550h may correspond to optical elements 520b-520h, respectively. Similarly, and as shown in FIG. 5, with respect to a second optical switch 502b, each of the switch outputs 552a-552h may correspond to an optical element of the plurality of optical elements 520a-520h. For example, and as shown in FIG. 5, switch output 552a may correspond to the first optical element 520a, and each of switch outputs 552b-552h may correspond to optical elements 520b-520h, respectively. Although not shown in FIG. 5, one of ordinary skill in the art in view of the present disclosure would appreciate that optical switches 502c-502h may also include a plurality of switch outputs, where each of the switch outputs corresponds to a respective optical element of the optical elements 520a-520h.

In some embodiments, the optical switch assembly 500 may include a plurality of optical switches (e.g., 8 electromechanical optical switches) each including a plurality of outputs. Further, the optical switch assembly 500 may include a plurality of optical elements (e.g., multimode combiners) each configured to receive a plurality of outputs from the plurality of optical switches as a plurality of optical element inputs (e.g., an optical switch transmits an output to an optical fiber that transfers the output to be input to an optical element). Additionally, or alternatively, an optical element of the plurality of optical elements may be configured to combine the inputs of the plurality of optical element inputs into an optical element output. In some embodiments, an optical element of the plurality of optical elements may be configured to receive and combine at least one output of each optical switch of the optical switch assembly.

For example, the plurality of optical switches of the optical switch assembly 500 may include a first optical switch 502a, a second optical switch 504b, and/or any number of additional optical switches 502c-502h. In some embodiments, the first optical switch 502a may include a plurality of first switch outputs 550 that may include switch outputs 550a-550h. Additionally, or alternatively, the second optical switch 502b may include a plurality of second switch outputs 552 that may include switch outputs 552a-552h. Further, the optical switch assembly 500 may include additional optical switches 502c-502h that may each include a plurality of additional switch outputs. In some embodiments, a switch output of the plurality of first switch outputs 550, a switch output of the plurality of second switch outputs 552, and/or an output of any of the plurality of additional switch outputs may have an associated orientation of the first optical switch 502a, the second optical switch 502b, and/or the number of additional optical switches 502c-502h. In some embodiments, the first optical switch 502a may be configured to receive a first switch input 503a and the second optical switch 502b may be configured to receive a second switch input 503b. Additionally, or alternatively, any additional optical switches of the optical switch assembly 500 may be configured to receive additional switch inputs 503c-503h.

In some embodiments, the optical switch assembly 500 may include a first optical element 520a, a second optical element 520b, and/or any number of additional optical elements 520c-520h. In some embodiments, the first optical element 520a may be configured to receive a switch output 550a of the first optical switch 502a, receive a switch output 552a of the second optical switch 502b, and/or a number of additional switch outputs of optical switches 502c-502h as a plurality of first optical element inputs. Further, the first optical element 520a may be configured to combine the plurality of first optical element inputs into a first optical element output 521a. Additionally, or alternatively, the second optical element 520b may be configured to receive a switch output 550b of the first optical switch 502a, receive a switch output 552b of the second optical switch 502b, and/or a number of additional switch outputs of optical switches 502c-502h as a plurality of second optical element inputs. Further, the second optical element 520b may be configured to combine the plurality of second optical element inputs into a second optical element output 521b. In some embodiments, the optical switch assembly 500 may include additional optical elements 520c-520h that may each be configured to receive a plurality of additional optical element inputs and combine the plurality of additional optical element inputs into additional optical element outputs 521c-521h.

In some embodiments, the optical switch assembly 500 may be configured to have M total inputs to the optical switch assembly 500 and/or N total outputs of the optical switch assembly 500 (e.g., an 8×8 optical switch assembly as shown in FIG. 5). Additionally, or alternatively, the optical switch assembly 500 may include M/I total optical switches, where each optical switch includes I inputs. In some embodiments, N and M may be equivalent. In some embodiments, N and M may not be equivalent. In some embodiments, the first optical element 520a, the second optical element 520b, and/or the additional optical elements 520c-520h may be configured to receive N or less optical element inputs and may be configured to combine the N or less optical element inputs into a single optical element output (e.g., the first optical element output 521a, the second optical element output 521b, and/or the like).

In some embodiments, the first optical switch 502a, the second optical switch 502b, and/or the additional optical switches 502c-502h may be and/or include electromechanical optical switches (e.g., similar to the electromechanical optical switch 450 depicted and described herein with respect to FIGS. 4D-4E). As will be appreciated by one of ordinary skill in the art in view of the present disclosure, the modified Spanke-Beneš topology may reduce the required number of optical switches (e.g., by half the amount) compared to a traditional Spanke-Beneš topology.

As will be appreciated by one of ordinary skill in the art in view of the present disclosure, the optical switch assembly 500 may include additional embodiments, such as any single embodiment or any combination of embodiments described herein. Although FIG. 5 shows example elements of the optical switch assembly 500, in some embodiments, the optical switch assembly 500 may include additional elements, fewer elements, different elements, or differently arranged elements than those depicted in FIG. 5.

FIG. 6 illustrates a crossbar array topology for an optical switch assembly 600, in accordance with an embodiment of the disclosure. As shown in FIG. 6, the optical switch assembly 600 may include a first optical switch 606, a second optical switch 608, and optical elements 610, 612, 614, 616, 618, and 620. In some embodiments, the optical switch assembly 600 may be configured to have switch inputs 602 and 604. Further, the switch input 602 may be input to the first optical switch 606, and the switch input 604 may be input to the second optical switch 608.

As shown in FIG. 6, the first optical switch 606 may include three switch outputs 609, 611, and 613, and the second optical switch 608 may include three switch outputs 615, 617, and 619. As will be appreciated by one of ordinary skill in the art in view of the present disclosure, the first optical switch 606 and/or the second optical switch 608 may include less than three switch outputs or more than three switch outputs.

In some embodiments, the first optical switch 606 may include a first switch orientation 336 and may be configured to have three possible orientations that may each be associated with one of the switch outputs 609, 611, and 613. Additionally, or alternatively, the second optical switch 608 may include a second switch orientation 638 and may be configured to have three possible orientations that may each be associated with one of the switch outputs 615, 617, and 619. In some embodiments, the first optical switch 606 and/or the second optical switch 608 may be an electromechanical optical switch (e.g., similar to the electromechanical optical switch 450 depicted and described herein with respect to FIGS. 4D-4E).

As shown in FIG. 6 with respect to the first optical switch 606, the switch output 609 may be configured to transmit to the optical element 610 (e.g., to an optical element input of the optical element 610), the switch output 611 may be configured to transmit to the optical element 612 (e.g., to an optical element input of the optical element 612), and/or the switch output 613 may be configured to transmit to the optical element 614 (e.g., to an optical element input of the optical element 614). As also shown in FIG. 6 with respect to the second optical switch 608, the switch output 615 may be configured to transmit to the optical element 616 (e.g., to an optical element input of the optical element 616), the switch output 617 may be configured to transmit to the optical element 618 (e.g., to an optical element input of the optical element 618), and/or the switch output 619 may be configured to transmit to the optical element 620 (e.g., to an optical element input of the optical element 620).

In some embodiments, and as shown in the exploded view portion of FIG. 6, one or more of the optical elements 610, 612, 614, 616, 618, and 620 may be and/or include a multimode combiner 632, where the multimode combiner 632 may be configured to receive a first input 628 and/or a second input 630 and combine the first input 628 and/or the second input 630 into an output 634. As shown in FIG. 6, the optical assembly may include a multimode combiner 632 for each output of each optical switch of the optical assembly. Further, the multimode combiner 632 may be configured to support the propagation of multiple modes of light. Additionally, or alternatively, one or more of the optical elements 610, 612, 614, 616, 618, and 620 may be and/or include a MEMS switch (e.g., a latching MEMS switch) supporting propagation of a single mode of light.

In some embodiments, a first optical signal may be input as the switch input 602. Further, the first optical signal may travel through the first optical switch 606 and may be transmitted via the switch output 609 to the optical element 610. In some embodiments, the first optical switch 606 may be configured to rotate to a new orientation (e.g., via a rotating stage 454 shown and described herein with respect to FIGS. 4D-4E) prior to receiving the first optical signal such that the first optical signal may be transmitted via one of the switch outputs 609, 611, or 613, depending on the requirements of the optical switch assembly 600.

In some embodiments, a second optical signal may be input as the switch input 604. Further, the second optical signal may travel through the second optical switch 608 and may be transmitted via the switch output 615 to the optical element 616. In some embodiments, the second optical switch 608 may be configured to rotate to a new orientation (e.g., via a rotating stage 454 shown and described herein with respect to FIGS. 4D-4E) prior to receiving the second optical signal such that the second optical signal may be transmitted via one of the switch outputs 615, 617, or 619, depending on the requirements of the optical switch assembly 600.

In some embodiments, the optical element 616 may be configured to receive and combine the switch output 615 and the output of the optical element 610 into a first combined output 622 of the optical switch assembly 600. Additionally, or alternatively, the optical element 618 may be configured to receive and combine the switch output 617 and the output of the optical element 612 into a second combined output 624 of the optical switch assembly 600. Further, the optical element 620 may be configured to receive and combine the switch output 619 and the output of the optical element 614 into a third combined output 626 of the optical switch assembly 600. As will be appreciated by one of ordinary skill in the art in view of the present disclosure, the optical switch assembly 600 may include more than three combined outputs or may include less than three combined outputs. In some embodiments, one or more of the optical elements 610, 612, 614, 616, 618, and 620 may receive a single input or may receive no input during an operative state. In some embodiments, the optical switch assembly 600 may transmit an optical signal from one or more of the outputs 622, 624, and/or 626 during an operative state.

As will be appreciated by one of ordinary skill in the art in view of the present disclosure, the optical switch assembly 600 may include additional embodiments, such as any single embodiment or any combination of embodiments described herein. Although FIG. 6 shows example elements of the optical switch assembly 600, in some embodiments, the optical switch assembly 600 may include additional elements, fewer elements, different elements, or differently arranged elements than those depicted in FIG. 6.

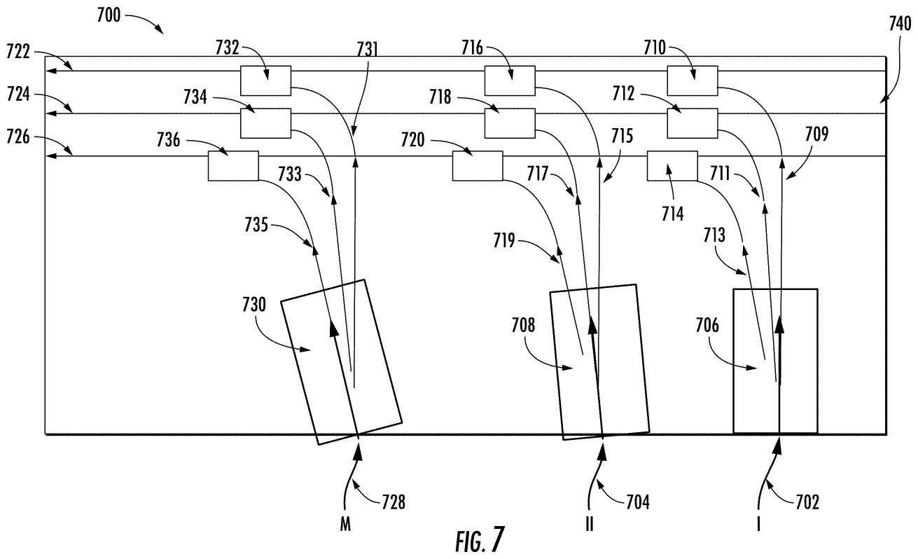

FIG. 7 illustrates a crossbar array topology for an optical switch assembly 700, in accordance with an embodiment of the disclosure. As shown in FIG. 7, the optical switch assembly 700 may include a first optical switch 706, a second optical switch 708, and an M^{th} optical switch 730, where M is a positive integer greater than two. In other words, the optical switch assembly 700 may include M total optical switches. As also shown in FIG. 7, the optical switch assembly 700 may include optical elements 710, 712, 714, 716, 718, 720, 732, 734, and 736, where three of the optical elements correspond to one of the M total optical switches. In other words, in the embodiment depicted in FIG. 7, the optical switch assembly 700 may include 3×M total optical elements, where each optical switch has three corresponding optical elements. As will be appreciated by one of ordinary skill in the art in view of the present disclosure, the M^{th} optical switch 730 and its associated optical elements 732, 734, and 736 may be representative of any additional optical switches and optical elements included in the optical switch assembly 700.

As shown in FIG. 7, the optical switch assembly 700 may include switch inputs 702, 704, and 728, as well as switch inputs for any additional optical switches included in optical switch assembly 700. Further, and as shown in FIG. 7, the switch input 702 may be input to the first optical switch 706, the switch input 704 may be input to the second optical switch 708, the switch input 728 may be input to the M^{th} optical switch 730, and the switch inputs for any additional optical switches included in the optical switch assembly 700 may be input to such additional optical switches.

As shown in FIG. 7, the first optical switch 706 may include three switch outputs 709, 711, and 713, the second optical switch 708 may include three switch outputs 715, 717, and 719, and the M^{th} optical switch 730 may include three switch outputs 731, 733, and 735. As will be appreciated by one of ordinary skill in the art in view of the present disclosure, the first optical switch 706, the second optical switch 708, the M^{th} optical switch 730, and/or any additional optical switches included in the optical switch assembly 700 may include less than three switch outputs or more than three switch outputs.

In some embodiments, the first optical switch 706 may be configured to have three possible orientations that may each be associated with one of the switch outputs 709, 711, and 713. Additionally, or alternatively, the second optical switch 708 may be configured to have three possible orientations that may each be associated with one of the switch outputs 715, 717, and 719. Further, the M^{th} optical switch 730 may be configured to have three possible orientations that may each be associated with one of the switch outputs 731, 733, and 735. In some embodiments, the optical switch assembly 700 may include additional optical switches that each have a plurality of orientations each associated with one switch output of a plurality of switch outputs. In some embodiments, the first optical switch 706, the second optical switch 708, the M^{th} optical switch 730, and/or any additional optical switches may be an electromechanical optical switch (e.g., similar to the electromechanical optical switch 450 depicted and described herein with respect to FIGS. 4D-4E).

As shown in FIG. 7 with respect to the first optical switch 706, the switch output 709 may be configured to transmit to the optical element 710, the switch output 711 may be configured to transmit to the optical element 712, and/or the switch output 713 may be configured to transmit to the optical element 714. As also shown in FIG. 7 with respect to the second optical switch 708, the switch output 715 may be configured to transmit to the optical element 716, the switch output 717 may be configured to transmit to the optical element 718, and/or the switch output 719 may be configured to transmit to the optical element 720. As also shown in FIG. 7 with respect to the M^{th} optical switch 730, the switch output 731 may be configured to transmit to the optical element 732, the switch output 733 may be configured to transmit to the optical element 734, and/or the switch output 735 may be configured to transmit to the optical element 736.

In some embodiments, the optical switch assembly 700 may include a plurality of additional optical switches 3 through M, where each of the additional optical switches may include a plurality of switch outputs transmitting to a plurality of optical switch elements in a manner similar to that shown and described herein with respect to the first optical switch 706, the second optical switch 708, and the M^{th} optical switch 730. Further, one or more of the optical elements 710, 712, 714, 716, 718, 720, 732, 734, and 736 and any additional optical elements of the optical switch assembly 700 may be and/or include a multimode combiner (e.g., similar to the multimode combiner 632 shown and described herein with respect to FIG. 6), where the multimode combiner may be configured to receive a first input and/or a second input and combine the first input and/or the second input into an output.

In some embodiments, the optical switches of the optical switch assembly 700 may include more than three switch outputs that may each be associated with an optical element such that the optical switch assembly 700 includes N total optical elements, where N is a positive integer. Further, an optical switch of the optical switch assembly 700 may include N/M switch outputs. Additionally, or alternatively, the N optical elements may be divided into M subsets of N/M optical elements such that each subset of the M subsets corresponds to one of M switches. For example, when the N optical elements are multimode combiners (e.g., multimode combiner 632) the N multimode combiners form M groups arranged to combine into a single output the j^{th} output of each of the M optical switches. In some embodiments, the optical switch assembly 700 may include N/M optical fibers 740 configured to optically couple corresponding optical elements from each subset of the M subsets of the N optical elements.

In some embodiments, a first optical signal may be input as the switch input 702. Further, the first optical signal may travel through the first optical switch 706 and may be transmitted via the switch output 709 to the optical element 710. In some embodiments, the first optical switch 706 may be configured to rotate to a new orientation (e.g., via a rotating stage 454 shown and described herein with respect to FIGS. 4D-4E) prior to receiving the first optical signal such that the first optical signal may be transmitted via one of the switch outputs 709, 711, or 713, depending on the requirements of the optical switch assembly 700.

In some embodiments, a second optical signal may be input as the switch input 704. Further, the second optical signal may travel through the second optical switch 708 and may be transmitted via the switch output 715 to the optical element 716. In some embodiments, the second optical switch 708 may be configured to rotate to a new orientation (e.g., via a rotating stage 454 shown and described herein with respect to FIGS. 4D-4E) prior to receiving the second optical signal such that the second optical signal may be transmitted via one of the switch outputs 715, 717, or 719, depending on the requirements of the optical switch assembly 700.

In some embodiments, an M^{th} optical signal may be input as the switch input 728. Further, the M^{th} optical signal may travel through the M^{th} optical switch 730 and may be transmitted via the switch output 731 to the optical element 732. In some embodiments, the M^{th} optical switch 730 may be configured to rotate to a new orientation (e.g., via a rotating stage 454 shown and described herein with respect to FIGS. 4D-4E) prior to receiving the M^{th} optical signal such that the M^{th} optical signal may be transmitted via one of the switch outputs 731, 733, or 735, depending on the requirements of the optical switch assembly 700. In some embodiments, the optical switch assembly 700 may include additional optical signals as inputs to additional optical switches.

In some embodiments, the optical element 732 may be configured to receive and combine the switch output 731 and the output of an M−1 optical element into an output 722 of the optical switch assembly 700. Additionally, or alternatively, the optical element 734 may be configured to receive and combine the switch output 733 and the output of another M−1 optical element into another output 724 of the optical switch assembly 700. Further, the optical element 736 may be configured to receive and combine the switch output 735 and the output of another M−1 optical element into another output 726 of the optical switch assembly 700. In some embodiments, the outputs of the M−1 optical elements may be a combination of prior optical element outputs. In some embodiments, one or more of the optical elements of the optical switch assembly 700 may receive a single input or may receive no input during an operative state. In some embodiments, the optical switch assembly 700 may transmit an optical signal from one or more of the outputs 722, 724, and/or 726 during an operative state.

As will be appreciated by one of ordinary skill in the art in view of the present disclosure, the optical switch assembly 700 may include additional embodiments, such as any single embodiment or any combination of embodiments described herein. Although FIG. 7 shows example elements of the optical switch assembly 700, in some embodiments, the optical switch assembly 700 may include additional elements, fewer elements, different elements, or differently arranged elements than those depicted in FIG. 7.

FIG. 8 illustrates an exemplary optical switch assembly 800, in accordance with an embodiment of the present disclosure. In some embodiments, the exemplary optical switch assembly 800 may include at least one optical switch 802 and at least one M port ASIC 804, where M may be an integer that defines the number of ports on an ASIC. Further, the at least one M port ASIC 804 may be configured to have M/2 ports of the M ports interfacing with external optical and/or electrical components to the exemplary optical switch assembly 800. Additionally, or alternatively, the at least one M port ASIC 804 may be configured to have M/2 ports of the M ports interfacing with the at least one optical switch 802 of the exemplary optical switch assembly via optical coupling 806.

In some embodiments, the optical switch assembly 800 may include additional M port ASICs such that the exemplary optical switch assembly 800 includes N total ports for interfacing with external optical and/or electrical components to the exemplary optical switch assembly 800. As will be appreciated by one of ordinary skill in the art in view of the present disclosure, in such an embodiment, the number of M port ASICs, including the at least one M port ASIC 802, may be (2*N)/M M port ASICs 805. Additionally, or alternatively, the optical switch assembly 800 may include M/2 optical switches 803, including the at least one optical switch 802. In some embodiments, an optical switch of the M/2 optical switches 803 may include I=2*N/M input ports. Further, an optical switch of the M/2 optical switches 803 may include 2*N/M output ports. In some embodiments, an optical switch of the M/2 optical switches 803 may be optically coupled 806 to one or more of the (2*N)/M M port ASICs.

Although FIG. 8 shows example elements of the exemplary optical switch assembly 800, in some embodiments, the exemplary optical switch assembly 800 may include additional elements, fewer elements, different elements, or differently arranged elements than those depicted in FIG. 8.

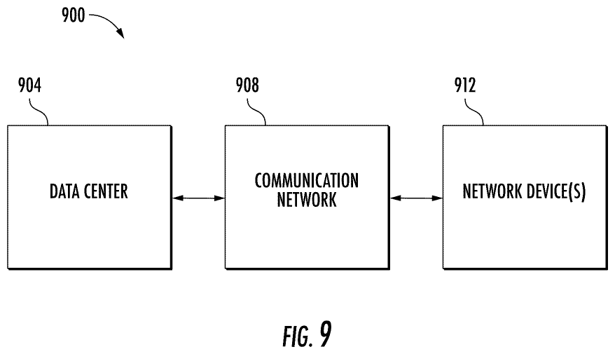

FIG. 9 illustrates a system environment 900, in accordance with an embodiment of the disclosure. The system environment 900 may include a datacenter 904, a communication network 908, and network device(s) 912.

The datacenter 904 may be a centralized facility designed to house computing resources and related components. The primary function of the datacenter 904 may be to support the infrastructure required for advanced computational tasks, for efficient, secure, and reliable operations. The datacenter 904 may include building and structural components, including power supplies, cooling systems, fire suppression systems, and physical security measures that are configured to maintain optimal operating conditions and protect the equipment from environmental hazards and unauthorized access. The core of the datacenter 904 may include high-performance servers or compute nodes, often arranged in racks, and connected through high-speed networks. These servers may include processors (e.g., central processing units (CPUs), graphics processing units (GPUs), and/or the like), memory (e.g., RAM), and storage solutions (e.g., hard disk drives (HDDs), solid state drives (SSDs), and/or the like). The hardware configuration may be optimized for parallel processing and high throughput, catering to the demands of high-performance computing (HPC) applications.

The datacenter 904 may include high-speed network equipment, such as network switches (e.g., Ethernet switches), routers, firewalls, and/or the like to facilitate fast and secure data transmission within the datacenter 904 (e.g., between the servers or compute nodes) and between external networks. The datacenter 904 may facilitate communication between servers or compute nodes through a network topology that ensures efficient data exchange, minimizes latency, and maximizes bandwidth. The network topology may define how various network devices, such as switches and routers, are interconnected for data flow. By implementing an effective network topology, the datacenter 904 can support high-performance computing tasks. Examples of various network topologies may include hierarchical networking topologies such as the fat tree topology, Slim Fly topology, Dragonfly topology, and/or the like. In some embodiments, the datacenter 904 may adhere to and/or include a modified Spanke-Beneš topology as shown and described herein with respect to FIG. 2, a crossbar array topology as shown and described herein with respect to FIG. 3, a crossbar array topology as shown and described herein with respect to FIG. 4, a crossbar array topology as shown and described herein with respect to FIG. 5, a crossbar array topology as shown and described herein with respect to FIG. 6, and/or a modified Spanke-Beneš topology as shown and described herein with respect to FIG. 7.

The communication network 908 may connect the datacenter 904 to network device(s) 912 and other external devices for data exchange and connectivity. Examples of communication network 908 that may be used to connect the datacenter 904 and the network device(s) 912 include an Internet Protocol (IP) network, an Ethernet network, an InfiniBand (IB) network, a Fiber Channel network, the Internet, a cellular communication network, a wireless communication network, combinations thereof (e.g., Fiber Channel over Ethernet), variants thereof, and/or the like. Each type of network offers specific advantages tailored to different operational requirements. For instance, an IP network or Ethernet network may provide widespread compatibility and ease of integration, supporting various protocols and applications across the datacenter 904 and the network device(s) 912 (and/or external devices). An InfiniBand network may offer high throughput and low latency, ideal for HPC environments where rapid data transfer and minimal delay are required. Fiber Channel networks may be employed for their robust performance in storage area networks (SANs), ensuring fast and reliable access to storage resources. Cellular and wireless communication networks may be used to extend connectivity to remote or mobile devices for increased flexibility and accessibility. The ability of the communication network 908 to incorporate multiple network types and configurations allows the datacenter 904 to adapt to diverse application needs, from general data communication to specialized HPC tasks.

The network device(s) 912 may include a variety of computing devices capable of sending and receiving signals over the communication network 908. The network device(s) 912 can range from personal computing devices to complex server configurations. Examples include Personal Computers (PCs), laptops, tablets, smartphones, and servers. The network device(s) 912 may facilitate user interactions with the datacenter 904, allowing for data input, retrieval, and processing from remote locations. In addition to individual computing devices, the network device(s) 912 may also include collections of servers or additional datacenters. For instance, these could be other datacenters similar to or the same as datacenter 904. Such an interconnection may allow for the formation of a distributed computing environment for improved redundancy, load balancing, and disaster recovery capabilities. By linking multiple datacenters, the system environment 900 can leverage geographically dispersed resources, optimizing performance and ensuring high availability.

As described herein, the datacenter 904 and/or the network device(s) 912 may include storage devices and processing circuitry for executing computing tasks, such as controlling the flow of data internally and over the communication network 908. The processing circuitry may comprise software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUS, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, it should be appreciated that the datacenter 904 and network device(s) 912 may include one or more communication interfaces for facilitating wired and/or wireless communication between one another and other unillustrated elements of the system environment 900. These communication interfaces may include a variety of technologies, including but not limited to Ethernet ports, fiber optic connections, Wi-Fi® transceivers, Bluetooth® modules, and cellular communication modules for integration and interoperability among the various components within the system environment 900.

Furthermore, it should be understood that the system environment 900 may include additional components and functionalities within the scope of the present disclosure. These components may comprise, without limitation, additional processing units, specialized accelerators (such as Tensor Processing Units or TPUs), enhanced security modules, and redundant power supplies. The inclusion of these elements is intended to ensure that the system environment 900 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the system environment 900.

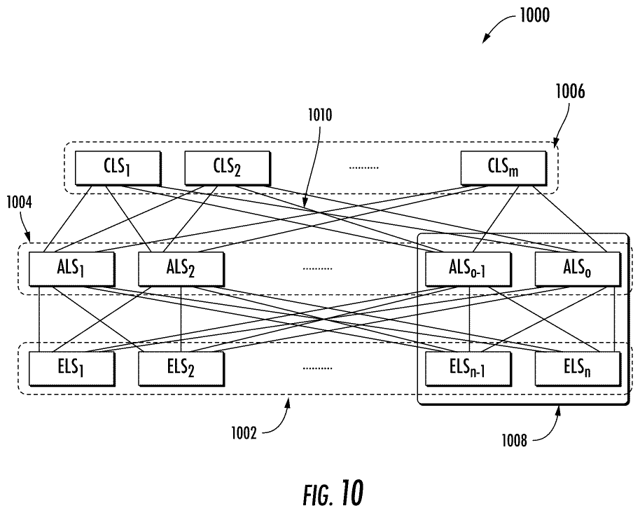

FIG. 10 illustrates a fat tree topology for a datacenter, in accordance with an embodiment of the present disclosure. However, it is to be understood that the present disclosure is not limited to a fat tree topology. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure.

As shown in FIG. 10, the fat tree topology may include three distinct layers: the edge layer 1002, the aggregation layer 1004, and the core layer 1006. The edge layer 1002, located at the bottom of the hierarchy, incorporates Top-of-Rack (ToR) switches. The edge layer 1002 may serve as the initial point of aggregation for traffic originating from the servers. The servers and server racks are generally connected to the edge layer 1002, although they are not illustrated in the figure. The edge layer 1002 may include a plurality of switches, designated as ELS₁, ELS₂, . . . , ELSₙ, as shown in FIG. 10. The aggregation layer 1004 may be positioned above the edge layer 1002 and may further consolidate traffic from multiple edge layer switches as ELS₁, ELS₂, . . . , ELSₙ. The aggregation layer 1004 may be composed of switches ALS₁, ALS₂, . . . , ALSₒ. The aggregation layer switches may be configured to aggregate data traffic from the edge layer 1002, ensuring efficient load balancing and data flow management. At the top of the hierarchy is the core layer 1006, which may provide high-speed interconnectivity and enables communication among different racks within the datacenter 904. The core layer 1006 may include a series of switches labeled as CLS₁, CLS₂, . . . , CLSₘ. These core layer switches may be configured to ensure that data can traverse the network quickly and efficiently, minimizing latency and maximizing bandwidth.

The switches within each layer (e.g., edge layer 1002, aggregation layer 1004, core layer 1006) may be 1U switches, where “U” refers to the industry-standard size for rack-mounted switches and servers. The switches may be electrical switches, optical switches, hybrid electro-optical switches, similar to the optical switch assembly 100 and/or the electromechanical switch 150 shown and described herein with respect to FIG. 1A-1E, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch. An optical switch, on the other hand, may function by directly routing optical signals without converting them to electrical signals. Each optical switch may include wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths.

The interconnections 1010 between the switches within the network topology may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Additionally, or alternatively, fiber optic cables may be employed for the interconnections 1010. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. In some embodiments, the interconnections 1010 between switches of different layers within the network topology may be accomplished with optical links using active optical cables and optical transceivers implemented in a pluggable form factor (also referred to as “pluggables”). Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication.

One such technology is Time Division Multiplexing (TDM). In TDM, multiple optical signals can be transmitted over a single optical fiber by assigning each optical signal a respective time slot and transmitting an optical signal during its assigned time slot. The time slots are allocated in a cyclic manner, with each optical signal transmitting a small amount of data during its assigned time slot. The time slots are very short, on the order of microseconds, and the cycle repeats many times per second, allowing for rapid data transfer.

Another technology is Frequency Division Multiplexing (FDM). In FDM, multiple optical signals can be transmitted over a single optical fiber by assigning each optical signal a respective frequency band. Each optical signal is modulated onto a respective carrier frequency to generate a modulated signal, and these modulated signals are combined and transmitted over a single optical fiber. At the receiver, the modulated signals are separated using filters (e.g., band-pass filters) that permit optical signals meeting specific frequency specifications to pass through while filtering out other signals. FDM allows optical links to simultaneously transmit multiple channels over the same frequency band.

Yet another technology is Wavelength Division Multiplexing (WDM). In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber. Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

Embodiments of the present disclosure may incorporate any of the aforementioned functionalities, including those of electrical switches, optical switches, hybrid electro-optical switches, or any combination thereof. Further, embodiments of the present disclosure may be configured to be versatile and adaptable, enabling replacement of any of the switches in the network topology, including those in the edge layer 1002, the aggregation layer 1004, and/or the core layer 1006. Additionally, or alternatively, the fat tree topology 1000 may replace the edge layer switches and/or aggregation layer switches with optical switches (e.g., similar to the optical switch assembly 100 and/or the electromechanical switch 150 shown and described herein with respect to FIG. 1A-1E) while the core layer switches (spine 1 to 4) remain electrical. As shown on the right-side of FIG. 10, an optical switch, may replace a POD 1008 of electrical switches. As will be appreciated by one of ordinary skill in the art in view of the present disclosure, the POD 1008, also referred to as point of delivery, may be generally understood as a collection of network elements (e.g., switches and/or servers) that may be repeatable for the topology at issue. In some embodiments, the modified fat tree topology may include topologies of the present disclosure shown and described herein with respect to FIGS. 2-8.

As will be appreciated by one of ordinary skill in the art in view of the present disclosure, the modified fat tree topology 1000 may include additional embodiments, such as any single embodiment or any combination of embodiments described herein. Although FIG. 10 shows example elements of the modified fat tree topology 1000, in some embodiments, the modified fat tree topology 1000 may include additional elements, fewer elements, different elements, or differently arranged elements than those depicted in FIG. 10.

As will be appreciated by one of ordinary skill in the art in view of this disclosure, the present disclosure may include and/or be embodied as an apparatus (including, for example, a photodetector, a device, and/or the like), as a method (including, for example, a manufacturing method, a computer-implemented process, and/or the like), or as any combination of the foregoing.

Although many embodiments of the present disclosure have just been described above, the present disclosure may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

While certain exemplary embodiments have been described and shown in the accompanying drawings, it is to be understood that such embodiments are merely illustrative of and not restrictive on the broad disclosure and that this disclosure is not to be limited to the specific constructions and arrangements shown and described, as various other changes, combinations, omissions, modifications and substitutions, in addition to those set forth in the above paragraphs, are possible. In light of this disclosure, those skilled in the art will appreciate that various adaptations, modifications, and combinations of the just described embodiments may be configured without departing from the scope and spirit of the disclosure. Therefore, it is to be understood that, within the scope of the appended claims, the disclosure may be practiced other than as specifically described herein.

1. An M×N optical switch assembly comprising:
M/I I×N/M switches, the M/I I×N/M switches comprising:
a first switch comprising (i) I inputs including a first switch input and (ii) N/M first switch outputs, wherein the first switch is configured to have a first switch orientation corresponding to one of the first switch outputs;
a second switch comprising (i) I inputs including a second switch input and (ii) N/M second switch outputs, wherein the second switch is configured to have a second switch orientation corresponding to one of the second switch outputs;
N optical elements, the N optical elements comprising:
a first optical element configured to (i) receive, from the first switch, a first switch output of the first switch outputs, (ii) receive one or more first additional optical element inputs comprising a second switch output of the second switch outputs, and (iii) transmit the first switch output and the one or more first additional optical element inputs via a first combined output; and
a second optical element configured to (i) receive, from the first switch, another first switch output of the first switch outputs, (ii) receive one or more second additional optical element inputs comprising another second switch output of the second switch outputs, and (iii) transmit the other first switch output and the one or more second additional optical element inputs via a second combined output.

2. The optical switch assembly of claim 1, wherein the first switch is configured to have multiple first switch orientations.

3. The optical switch assembly of claim 2, wherein each first switch orientation of the multiple first switch orientations is configured to correspond to a respective first switch output of the first switch outputs.

4. The optical switch assembly of claim 1, wherein the second switch is configured to have multiple second switch orientations.

5. The optical switch assembly of claim 4, wherein each second switch orientation is configured to correspond to a respective second switch output of the second switch outputs.

6. The optical switch assembly of claim 1, wherein M is a positive integer, wherein each of the M/I switches is optically coupled within the optical switch assembly, and wherein the M/I switches comprise the first switch and the second switch.

7. The optical switch assembly of claim 6, wherein N is a positive integer, and wherein the N optical elements comprise the first optical element and the second optical element.

8. The optical switch assembly of claim 7, wherein N/M is an integer and corresponds to a number of switch outputs per switch of the M switches, and wherein the N optical elements are divided into M subsets of N/M optical elements and each subset of the M subsets of the N optical elements corresponds to a switch of the M switches.

9. The optical switch assembly of claim 8, wherein the N/M switch outputs of a switch are each optically coupled to a corresponding optical element of the corresponding subset of N/M optical elements to the switch.

10. The optical switch assembly of claim 8, wherein the optical switch assembly has increased resiliency by defining a number of inputs of a set of M inputs to the optical switch assembly and a number of switch outputs of the N/M switch outputs per switch of the M/I switches to remain unused during operation.

11. The optical switch assembly of claim 1, wherein the first switch is an electromechanical switch.

12. The optical switch assembly of claim 1, wherein the optical switch assembly is configured to support propagation of multiple modes of light.

13. The optical switch assembly of claim 1, wherein the first optical element is a MEMS, and wherein the optical switch assembly is configured to support propagation of a single mode of light.

14. The optical switch assembly of claim 1, wherein the optical switch assembly is configured to support different types of inputs, outputs, and intermediate multi-mode fibers.

15. The optical switch assembly of claim 1, wherein the first optical element is a multimode combiner.

16. The optical switch assembly of claim 1, wherein the optical switch assembly is deployed in a datacenter.

17. An optical system comprising a plurality of optical switch assemblies, wherein an optical switch assembly of the plurality of optical switch assemblies comprises:
M/I I×N/M switches, the M/I I×N/M switches comprising:
a first switch comprising (i) I inputs including a first switch input and (ii) N/M first switch outputs, wherein the first switch is configured to have a first switch orientation corresponding to one of the first switch outputs;
a second switch comprising (i) I inputs including a second switch input and (ii) N/M second switch outputs, wherein the second switch is configured to have a second switch orientation corresponding to one of the second switch outputs;
N optical elements, the N optical elements comprising:
a first optical element configured to (i) receive, from the first switch, a first switch output of the first switch outputs, (ii) receive one or more first additional optical element inputs comprising a second switch output of the second switch outputs, and (iii) transmit the first switch output and the one or more first additional optical element inputs via a first combined output; and
a second optical element configured to (i) receive, from the first switch, another first switch output of the first switch outputs, (ii) receive one or more second additional optical element inputs comprising another second switch output of the second switch outputs, and (iii) transmit the other first switch output and the one or more second additional optical element inputs via a second combined output,
wherein a first optical switch assembly of the plurality of optical switch assemblies is optically coupled to a remaining plurality of optical switch assemblies.

18. The optical system of claim 17, wherein the first optical element of the N optical elements of the first optical switch assembly is configured to be optically coupled to a corresponding optical element of each of the remaining plurality of optical switch assemblies.

19. The optical system of claim 18, wherein at least one of the one or more first additional optical element inputs originate from a corresponding optical element of a neighboring optical switch assembly of the plurality of optical switch assemblies.

20. The optical system of claim 17, wherein the first optical element of the N optical elements of the optical switch assembly is configured to receive an output of the plurality of outputs of an optical switch for each of the remaining optical switch assemblies of the plurality of optical switch assemblies of the optical system as the one or more first additional optical element inputs.

21. The optical system of claim 17, wherein the first optical switch is configured to transmit from a single output of the N/M first switch outputs at a given time.

22. The optical system of claim 17, wherein the optical system is deployed in a datacenter.

23. A system, comprising a plurality of network devices configured in a hierarchical network topology, wherein at least one network device of the plurality of network device comprises:
an architecture of optical networks comprising an optical network topology for an optical switch assembly comprising:
M/I I×N/M switches, the M/I I×N/M switches comprising:
a first switch comprising (i) I inputs including a first switch input and (ii) N/M first switch outputs, wherein the first switch is configured to have a first switch orientation corresponding to one of the first switch outputs;
a second switch comprising (i) I inputs including a second switch input and (ii) N/M second switch outputs, wherein the second switch is configured to have a second switch orientation corresponding to one of the second switch outputs;
N optical elements, the N optical elements comprising:
a first optical element configured to (i) receive, from the first switch, a first switch output of the first switch outputs, (ii) receive one or more first additional optical element inputs comprising a second switch output of the second switch outputs, and (iii) transmit the first switch output and the one or more first additional optical element inputs via a first combined output; and
a second optical element configured to (i) receive, from the first switch, another first switch output of the first switch outputs, (ii) receive one or more second additional optical element inputs comprising another second switch output of the second switch outputs, and (iii) transmit the other first switch output and the one or more second additional optical element inputs via a second combined output.

24. The system of claim 23, wherein the architecture of optical networks is configured as an electromechanical switch and multimode combiner based optical network in a crossbar array or modified Spanke-Beneš network topology.
